(19) United States
(12) Patent Application Publication
(10) Pub. No.: US 2006/0095369 A1
(43) Pub. Date: May 4, 2006

(54) Device, method and system for authorizing transactions

(76) Inventor: Eyal Hofi, Or Yehuda (IL)

Correspondence Address: Martin D. Moynihan;PRTSI, Inc., P.O. Box 16446, Arlington, VA, 22215, US

(21) Appl. No.: 11/305,032

(22) Filed: Dec. 19, 2005

Related U.S. Application Data
(63) Continuation-in-part of application No. 09/976,044, filed on Oct. 15, 2001.

(51) Int. Cl. G06Q 40/00; G06Q 99/00; H04L 9/00; H04K 1/00

(52) U.S. Cl. 705/39; 705/76

(57) ABSTRACT

A system, device, and method for authorizing transactions of a plurality of applications. The system comprises a plurality of application servers operable to authorize transactions of applications and a plurality of user devices. Each transaction authorization is dependent upon receipt, by the authorizing server, of a transmitted code verified by the server as being an appropriate transaction code for the selected application. Each user device is operable to verify the identity of a user by comparing real-time biometric input from the user with data derived from biometric input provided by the user during device initialization. Each user device is further operable to select an application from among a plurality of applications and to emit a non-repeating non-guessable transaction code appropriate for the selected application. Emission of the transaction code is dependent upon biometric verification, by the user device, of the user's identity.

### RELATED APPLICATIONS

This application is a Continuation-In-Part (CIP) of U.S. application Ser. No. 09/976,044, filed on Oct. 15, 2001. The contents of the above Applications are incorporated herein by reference.

### FIELD AND BACKGROUND OF THE INVENTION

The present invention relates to systems, devices and methods for authorizing transactions by authorized users, while preventing unauthorized users from transacting, using credit and/or debit.

Credit/debit card theft and credit/debit card fraud are well-know problems in the world of business. With the development of e-commerce and other forms of remote purchasing, the problem has been exacerbated, in that today a customer can easily place an order and make a purchase by providing only a credit card number, without needing to demonstrate that he actually has physical possession of the credit card whose number he provides, and without having to identify himself in a verifiable manner.

In partial response to this and similar problems, various systems have been developed and marketed, utilizing biometric sensing to ascertain or to verify the identity of individuals involved in transactions or requesting access to physical sites and to computer networks. Each issue of Biometric Digest contains dozens of references to new products and services utilizing such biometric devices as fingerprint imaging, voice recognition, retinal pattern scans, signature verification, iris scans, hand geometry scans and facial structure scans, to identify individuals or to verify the ostensible identity of individuals. Applications range from control of access to physical sites and to computer systems, to authorization of financial operations such as payments at ATM machines and unattended supermarket checkout lines.

Information gleaned from biometric sensors is used in a variety of prior art systems to identify individuals, usually by comparing input data to multiple records in a database of previously collected biometric data from many individuals. Police scanning of fingerprints of a person being arrested, to determine if he has a criminal record, is an example of using biometric data to identify an individual. Similarly, biometric information is used in a variety of prior art systems to verify the ostensible identity of an individual, usually by comparing previously stored biometric data from that individual to currently received biometric data from someone purporting to be that individual, to determine if the samples are sufficiently similar to be declared a match. Scanning the fingerprints of the user of a credit card to verify that that user is the legal owner of the card is an example of using biometric data to verify an ostensible identity.

Recent progress in the development of practical biometric sensors of various types has been impressive. Every month sees the announcement of new sensors and new products utilizing them, and the trend is to sensor apparatus that is increasingly more reliable, smaller, cheaper, faster, and easier to use.

Finger-print readers, for example, embodied in devices the size of a computer mouse or smaller, are to be found in the Biolink system from Protective Security Management (www.prosecman.com.auibiolink), in systems from Applied Biometrics Products Inc. (www.appliedbiometrics.net), in access control systems sold by Biometric Identification Inc., of Sherman Oaks, Calif., in PC compatible devices from Shuttle Technology Inc., and in devices from TMN Inc., from BioTech Solutions Sdn Bhd (www.biotechsolutions.com), from NextWave Solutions (www.next-wave-solutions.com), from Kinetic Sciences Inc. (www.kinetic.bc.ca), from Taiwan Tai-Hao Enterprise Co., Ltd (www.tai-hao.com), from Authentec Inc. (www.authentec.com), from Veridicom Inc., from SGS-Thomson Microelectronics, from Thomson CSF and from Harris Corp., among others.

In a parallel development, the advent of “smart cards”, devices conforming to, or similar to, the ISO 7816 standard (which is incorporated herein by reference), has enabled to provide a form of credit card with the ability to contain large amounts of user-specific data and to engage in complex computational interactions with a business-transactional environment.

Several vendors have utilized smart cards in conjunction with biometric sensing, in schemes designed to verify the identity of a smart card user, typically by recording biometric data derived from an authorized user in the memory of a smart card, then utilizing a biometric sensor in a card reader to glean biometric data from an actual user in real time. A processor, typically in the card reader, is then used to compare biometric data from an authorized user, stored in the card, to biometric data input from a current user, to determine if they are the same person. GemPlus Inc., for example, sells the GemPC-Touch440-Biomet Reader, a device which reads biometric fingerprint information from a user's finger, recalls stored fingerprint information from an authorized user stored in the memory of a smart card, and compares the two. Keyware Technologies (www.keyware.com) also sells a similar device, and U.S. Pat. No. 5,473,144 to Mathurin, which is incorporated herein by reference, describes a device of this sort.

Recent progress in miniaturization of sensors such as fingerprint scanners has reduced the size and power requirements of such devices to such an extent that it begins to be possible to install the sensors directly on a credit card or similar device. PremierElect (www.premierelect.co.uk), sells a fingerprint scanner and identity verification system embodied in a PCMCIA card. AuthenTec Inc. sells several fingerprint scanning modules whose dimensions are substantially compatible with the standardized external dimensions of credit cards and smart cards, as can be seen with respect to their “EntrePad” sensor (www.authentec.com/products/EntrePad Overview.cfm) and their “FingerLoc” sensor (www.authentec.com/products/af-s2.cfm).

However, several important limitations are inherent in all the above-mentioned systems for identity verification and action authorization, and in similar systems.

A disadvantage of some systems is that their use requires the recording of a user's biometric data, such as his fingerprint, in a central database, whence it may be compared to real-time data gleaned from a user during a transaction. Yet, users are typically reluctant to having their fingerprints or other biometric data collected in a database over which they have no control, and are similarly resistant to having their biometric data transmitted over public communications networks, where they are subject to capture and misuse by computer hackers or other criminal elements. As for systems similar to the GemPC-Touch440-Biomet Reader previously mentioned, which systems do not require transmitting a users biometric data over public communications networks, such systems do, however, require communicating authorization-enabling information, such as reports of a user's identity, over communications networks over various sorts, and these communications are also subject to hacking, spoofing, and undesirable and unauthorized activity of various sorts. This problem is particularly acute in contexts in which there is no direct communications link between the device used to verify a user's identity and the device used to authorize a transaction, as is the case, for example, in many contexts of credit card use today.

Thus, there is a widely felt need for, and it would be highly advantageous to have, a system for authorizing activities and transactions which is capable of verifying that a user is an authorized user of a device, yet which does not require the storage of users' fingerprints or other biometric data in a central storage system, and which further does not require the transmission of users' biometric data over data communication systems linking remote terminals to a central authorizing authority, and which enables communicating authorization-enabling information to a central transaction-authorizing authority in a manner which cannot be hacked, spoofed, or otherwise simulated by an unauthorized user. Further, there is a widely felt need for, and it would be highly desirable to have, a system for authorizing actions and transactions which communicates enabling information between a peripheral station and a central authorizing authority in such a manner that acts of intercepting the communication, copying the communication, and reproducing the communication are devoid of any advantage to an unauthorized user or criminal element attempting these activities.

A further disadvantage of such systems as the GemPlus, the Keyware, and the Mathurin systems cited above is that they require, for their use, card readers equipped with a biometric sensor such as a fingerprint scanner, and software compatible with the software systems and/or data formats implemented in the smart card. Such a system is adequate for some applications, particularly applications having a limited number of fixed points of use, such as employee access control at a work site for example. Yet because they require specialized equipment at each usage site, such systems are inadequate as a solution for general-purpose utilizations such as the authorizing financial transactions in the wide-ranging world of travel and commerce.

Thus, there is a widely felt need for, and it would be highly desirable to have, a system for authorizing actions and transactions which comprises a peripheral device, operable to identify a user to the system, which is highly portable and entirely self-contained.

It is a further disadvantage of all known identification and authorization systems that they provide no solution to the difficult problem of enabling secure transactions based on credit card numbers used in absence of a physical credit card. Of course, communication protocols exist which protect data communication of credit card numbers in the context of e-commerce over the Internet, but such systems are of no help at all in preventing unauthorized use of a credit card number in Internet e-commerce, or in a business transaction conducted over the telephone, once an unauthorized user knows his victim's credit card number and the card's expiration date.

Since credit card numbers and the cards' expiration dates may easily be obtained by dishonest employees of legitimate companies, by theft of a credit card, or in a variety of other ways, there is a widely felt need for, and it would be highly desirable to have, a device and system enabling identifying of a credit card user, and authorization of a transaction by such a user over the telephone or the Internet, which protects users, vendors, banks and the credit card companies themselves from fraudulent use of credit card information.

The present application is claims priority from U.S. Patent Application No. 2003/0074317, filed on Oct. 15, 2001. That application disclosed a solution for authorization of transactions overcoming the various disadvantages and limitations of prior art systems described above, a solution wherein a biometric sensor on a portable card uses a set of non-deducible non-repeating one-time codes to communicate with a transaction authorization server, thus enabling to unambiguously verify the identity of the user of the card and to communicate that identity to a remote authorization server in a manner which cannot be hacked or compromised. It is, however, a disadvantage the solution there described that the cost per unit of a portable authorization card which comprises a biometric sensor and complex communications software may be too high to permit widespread popular adoption of the described system for single-application uses.

We also note a well-known disadvantage of the conventional authorization cards and credit cards in popular use today, namely that their very popularity has created an uncomfortable situation known to every user whose wallet literally bulges with the multiplicity of cards required for normal functionality of a citizen in the modern western world: credit cards, membership cards, drivers license, diving license, pilot's license, gun permit, retail discount cards, building entrance cards, security cards, bus passes, employee cards, passport, health service card, and other identification and authorization cards of sundry sorts. The average user today carries with him at all times a card collection large enough to be uncomfortable and unwieldy to carry, and which is a nightmare to take care of when a user's wallet is lost or stolen.

We further note that for some applications, several prior art cards are required to complete a single transaction. A customer purchasing liquor may be required to produce an identity card followed by a credit card. A supermarket purchase may require a discount card followed by a credit card.

Thus, there is a widely felt need for, and it would be highly desirable to have, a system for identifying a user and authorizing transactions, which system enables a plurality of application servers to authorize transactions based on secure communication with a user-specific self-contained and highly portable user-controlled peripheral device such as a walled-sized card, the device being operable to verify user identity by examination of biometric user input and being further operable to communicate securely with a plurality of transaction authorizing application servers. Such a card would enable a single physical card to serve a plurality of applications, and would thus be easy to carry as well as easy to use.

### SUMMARY OF THE INVENTION

According to one aspect of the present invention there is provided a system for authorizing a transaction requested by an authorized user while preventing authorization of a transaction requested by an unauthorized user. The system comprises a user device and a server device. The user device comprises (a) an identity verification unit operable to receive current biometric input from a current user and to utilize that biometric input to determine if the current user is an authorized user of the device; (b) a transaction code provider operable to provide a transaction code if, and only if, the identity verification unit determines that a current user is an authorized user; and (c) a first communication device operable to communicate the provided transaction code. The server device comprises (a) a second communication device operable to receive a communicated code; (b) a transaction code verifier operable to determine if a received communicated code is a transaction code provided by the transaction code provider, and (c) an authorizer operable to authorize a transaction if and only if said transaction code verifier determines that a received communicated code is a verified transaction code.

According to further features in preferred embodiments of the invention described below, the system further comprises modules for executing a business transaction authorized by the authorizer.

According to still further features in the described preferred embodiments, the user device is formed in a size and shape substantially similar to a credit card or a smart card, and preferably conforms to ISO standard 7816.

Preferably, the user device includes a replaceable or rechargeable battery or a power supply of another sort, such as a photocell.

Preferably, the identity verification unit comprises a biometric sensor, which may be a fingerprint sensor such as an optical sensor or a capacitance sensor. Alternatively, the biometric sensor may include a microphone, a sound recording device, a digital camera, a voice recognition system, a retinal pattern scanner, a signature verification system, an iris scanning module, a module operable to measure part of a body of a user such as a feature of a hand or a face, or a module operable to measure a movement or a behavior of a user, or a module operable to characterize a pattern of physical interaction between the biometric sensor and a user.

According to still further features in the described preferred embodiments, the identity verification unit further comprises a first data memory operable to store biometric data of an authorized user. Stored biometric data may be calculated data resulting from a calculation based on at least one sample of input from a biometric sensor operated by a user identified as an authorized user of the user device.

According to still further features in the described preferred embodiments, the identity verification unit further comprises a first processor operable to compare biometric data of an authorized user stored in the first data memory to current biometric data sensed by the biometric sensor. The first processor is further operable to determine that said current user of the user device is an authorized user of the user device whenever detected differences between the biometric data of an authorized user and the current biometric data of a current user are less than a predetermined amount of difference.

According to still further features in the described preferred embodiments, the first communication device of the user device comprises a graphical display module operable to optically display a transaction code provided by the transaction code provider. The graphical display module may include an LCD or a light-emitting element such as an organic compound operable to emit light when electrically powered. Alternatively, the graphics display module comprises a plasma display. The graphics display module is operable to display the transaction code in a machine-readable format such as a barcode or a format readable by an optical character recognition system or in a format readable by a human user. Alternatively, the first communication device comprises a machine readable memory, and further comprises electrical connections operable to enable reading of the machine readable memory by a processor external to the user device. Further alternatively, the first communication device comprises a transmitter such as a radio frequency transmitter, an emitter of optical frequencies or infrared frequencies. Alternatively the transmitter is operable to transmit a transaction code to a receiver, which is operable to transmit the transaction code to a second communication device of the server device. Further alternatively, the transmitter comprises a sound generator operable to generate frequencies audible, or inaudible, to the human ear.

Preferably, the first communication device is operable to communicate the transaction code during a limited lapse of time, and to cease communicating said transaction code at expiration of that lapse of time. Preferably, the lapse of time is less than two minutes duration, and most preferably is about 30 seconds.

According to still further features in the described preferred embodiments, the transaction code provider comprises a first code memory operable to store a set of substantially random digital codes, and a selector operable to select a next transaction code from among codes stored in the first code memory, and a first disqualifier for disqualifying a code stored in the first code memory from future selection by the selector or for removing a transaction code from the first code memory, thereby preventing its future selection by the selector. The transaction code provider is operable to provide a non-predictable transaction code, and is designed and constructed to refrain from providing a transaction code previously provided by the transaction code provider.

According to still further features in the described preferred embodiments, the transaction code verifier comprises a second code memory operable to store a set of substantially random digital codes. Preferably, the second code memory stores such codes. The user device comprises a first code memory storing a first set of substantially random digital codes, and the server device comprises a second code memory storing a second set of substantially random digital codes, the first set of substantially random digital codes and the second set of substantially random digital codes being identical, or substantially similar.

According to still further features in the described preferred embodiments, the transaction code verifier comprises a code tester for testing a received code to determine if the received code is a transaction code provided by the user device. Preferably, the code tester comprises a code searcher operable to compare a received code to codes stored in the second code memory to determine if the received code is identical to a code stored in second code memory, and the authorizer is operable to authorize a transaction if and only if the received code is determined to be identical to a code stored in second code memory. The system preferably includes a second disqualifier operable to disqualify a selected code stored in second code memory when that code is found by the code searcher to be identical to a received code, the disqualification preventing the disqualified code from being examined by the code searcher during subsequent searches of codes stored in second code memory. Also, a second disqualifier may be operable to remove from second code memory a selected code stored in therein when the selected code has been found to be identical to a received code. Alternatively, the transaction code provider comprises a first algorithmic pseudo-random code generator operable to generate a transaction code and the transaction code tester comprises a second algorithmic pseudo-random code generator operable to generate a set of generated codes, said transaction code tester being further operable to compare a received code to each generated code of the set of generated codes, and the authorizer is operable to authorize a transaction if and only if the received code is found to be identical to a generated code belonging to the set of generated codes.

According to still further features in the described preferred embodiments, the user device comprises a portable device and a stationary device. Preferably, the portable device is formed in a size and shape substantially similar to a credit card and comprises a memory operable to store biometric data of an authorized user, and the stationary devices comprises a biometric sensor.

According to another aspect of the present invention there is provided a user-identifying device operable to identify an authorized user thereof, comprising a memory for storing biometric data of an authorized user, a biometric sensor operable to receive current biometric data of a current user, a processor operable to compare said current biometric data of said current user to said stored biometric data of said authorized user, and a communicator operable to communicate information, said information being communicated only if the processor determines that said current biometric data is similar to the stored biometric data.

According to further features in preferred embodiments of the invention described below the device further comprises a transaction code provider operable to provide a non-predictable transaction code useable to provoke authorization of a business transaction by a transaction authorizing authority, the transaction code being provided by the transaction code provider and communicated by the communicator only if the processor determines that the current biometric data is similar to the stored biometric data. According to alternate preferred embodiments, however, the device is operable without reference to a transaction code, being useable to provide confirmation of identify of a current user by communicating information, preferably pre-determined information, if and only if the processor determines that said current biometric data is similar to said stored biometric data.

According to yet another aspect of the present invention there is provided a method for authorizing a transaction requested by an authorized user of a transaction authorizing system and for preventing authorization of a transaction requested by an unauthorized user of the transaction authorizing system, the method comprising utilizing a user device to receive biometric data from a current user, compare said received biometric data from a current user to stored biometric data from an authorized user, to determine if they are similar, and provide and communicate a non-predictable transaction code if and only if the stored biometric data from an authorized user and the received biometric data from a current user are determined to be similar, and utilizing a server device to receive a communicated transaction request accompanied by a communicated code, determine whether the received communicated code is a transaction code provided by the user device, and authorize a transaction if and only if the received communicated code is determined to be a transaction code provided by the user device, thereby enabling authorization of a transaction requested by an authorized user, and preventing authorization of a transaction requested by an unauthorized user.

According to still further features in the described preferred embodiments the method further comprises executing a business transaction authorized by the authorizer. Receipt of receiving biometric data from a current user may include receiving fingerprint data, sound data, voice data, optical data, data generated by said current user writing a signature, retinal pattern data, iris pattern data, body part measurement data such as measures of features of a face or a hand, measurements of movements of a user, or of a behavior, or of a pattern of physical interaction between said user device and said current user. Comparing said received biometric data from a current user to said stored biometric data from an authorized user preferably includes determining whether detected differences between said stored biometric data of an authorized user and said received biometric data of a current user are less than a predetermined amount of difference.

According to still further features in the described preferred embodiments, communicating the non-predictable transaction code includes displaying said transaction code on a graphical display module in machine-readable format such as barcode format or a format readable by an optical character recognition system, and/or in a format readable by a human user.

According to still further features in the described preferred embodiments, communicating the non-predictable transaction code includes utilizing a processor external to said user device to read a machine readable memory of said user device.

According to still further features in the described preferred embodiments, communicating the non-predictable transaction code includes receiving communication of a transaction code from said user device and communicating said transaction code to said server device.

According to still further features in the described preferred embodiments, the method further comprises limiting a duration of the communication of the transaction code to a period of less than two minutes, and preferably of approximately 30 seconds.

According to still further features in the described preferred embodiments, the method further comprises providing the transaction code by selecting the transaction code from among a set of substantially random digital codes stored in a memory of the user device, and verifying the received code by determining if a received code is identical to a code stored in a memory of the server device.

According to still further features in the described preferred embodiments, the method further comprises providing a transaction code by utilizing a processor of the user device to generate a transaction code by utilizing a pseudo-random code generation algorithm.

According to yet another aspect of the present invention there is provided a system for authorizing transactions of a plurality of applications, comprising:

(a) a set of at least one application servers each operable to authorize transactions of at least one application, each transaction authorization being dependent upon receipt, by the authorizing server, of a transmitted code, and further being dependent upon verification by the server that the received code is an appropriate transaction code for the selected application; and

(b) at least one user device operable to verify identity of a user by comparing real-time biometric input from the user with data derived from biometric input provided by the user during initialization of the user device, the user device being further operable to select an application from among a plurality of applications and to emit a non-repeating non-guessable transaction code appropriate for the selected application, emission of the transaction code being dependent upon the biometric verification of user identity.

According to further features in the described preferred embodiments, the user device is further operable to communicate the transaction code to the application server. Communication of the transaction code to the application server may be of a sort selected from a group consisting of Internet communication, radio communication, LAN communication, WAN communication, and infra-red communication.

According to further features in the described preferred embodiments, the user device is operable to select the selected application according to user input provided by a user to a user interface of the user device.

According to still further features in the described preferred embodiments, the user device is operable to select the selected application according to data input received from an electronic device external to the user device.

According to still further features in the described preferred embodiments, the user device is operable to select the selected application according to an application code emitted by one of the plurality of application servers, the application code serving to identify the selected application. The application code may be received by the user device from an electronic communication, be stored in a memory of the user device, and subsequently be used to identify an application code received by the user device during communication with the one of the plurality of application servers.

According to still further features in the described preferred embodiments, the application code is a code installed in a memory of the user device prior to initialization of the user device.

According to still further features in the described preferred embodiments, the user device is operable to transmit to a server device of the set of server devices a transaction authorization request which comprises the transaction code and further comprises an application code identifying the selected application.

According to still further features in the described preferred embodiments, the application code is received by the user device through an electronic communication, is stored in a memory of the user device, and is subsequently retransmitted by the user device as a component of a transaction authorization request transmitted to a server device.

According to still further features in the described preferred embodiments, at least one of the server devices is operable to transmit to the user device an application code recognizable by the user device as identifying an application for which the one of the plurality of server devices is operable to authorize transactions.

According to still further features in the described preferred embodiments, the system further comprises a plurality of the user devices, and wherein a same application code identifies a same application to each of the plurality of user devices. Alternatively, the application code is unique to one of the applications and is further unique to one of the plurality of user devices.

The at least one application server may be operable to transmit the transaction code to the user device, and the user device operable to retransmit the received transaction code to the application server as a component of a transaction authorization request. Alternatively, the application server is operable to generate the transaction code according to a rule, the application server is further operable to transmit the rule to the user device and the user device is operable to receive the rule from the application server and is further operable to emit a transaction code generated according to the received rule.

Preferably, initialization of ability of at least one application server of said set of application servers to communicate with said user device is dependent on transmission of a connection code from said at least one application server to said user device, said transmitted code being recognizable as a connection code by successful comparison with a connection code installed in said user device prior to said initialization.

According to still further features in the described preferred embodiments, at least one of the application servers is operable to transmit to the user device a communication which comprises a non-repeating non-guessable code, and the user device is operable to utilize the received code to verify that the received communication originated from the one of the application servers.

The user device may be portable, and may be embodied as a card in credit-card format.

The user device may be operable to present, in graphic format on a display of the device, user-identifying information stored in a memory of the user device. The presentation of the user-identifying information may be dependent upon the biometric verification of user identity.

Preferably, the user device is enabled to change information stored in the memory of the user device only after biometric verification of user identity.

Alternatively, a user of the user device is enabled to change information stored in the memory of the user device only after biometric verification of user identity.

According to yet another aspect of the present invention there is provided a user device for identifying a user during authorization of a transaction, comprising:

(a) a biometric input device operable to receive first biometric input from a first user during initialization of the user device and further operable to receive second biometric input from a second user requesting authorization of a transaction;

(b) a first memory operable to store data derived from the first biometric input;

(c) a processor operable to determine, by comparing the second biometric input with the stored data, whether the first user and the second user are a same user;

(d) a transaction code generator operable to generate a non-repeating non-guessable code recognizable by an application server to which it is addressed as being a transaction code appropriate for authorizing a transaction of an application running on the server; and

(e) a selection mechanism for selecting a selected application from among a plurality of applications,

the user device being operable to emit a transaction code appropriate for authorizing a transaction of an application selected by the selection mechanism if and only if the processor determines that the first user and the second user are a same user.

According to still further features in the described preferred embodiments, the transaction code generator is enabled to generate the non-repeating non-guessable code during a pre-set limited time duration following each instance of determination by the processor that the first user and the second user are a same user.

According to still further features in the described preferred embodiments, the device further comprises a user interface useable by a user to indicate a choice of applications, and wherein the application selection mechanism is operable to select an application from among a plurality of applications according to a choice expressed by a user through the user interface.

Alternatively, the selection mechanism is operable to select an application according to an application code received from an external electronic device.

Preferably, the device is embodied in credit-card format.

According to yet another aspect of the present invention there is provided a commercial method providing a transaction authorization service for a plurality of applications, comprising:

(a) providing a plurality of user devices each operable store data derived from biometric input from a user supplied during initialization of the user device, each user device further being operable to verify identity of a user by comparing real-time biometric input supplied by the user to the stored data, the user device further being operable to select an application from among a plurality of applications and further being operable to emit a non-repeating non-guessable transaction code appropriate for authorizing a transaction of the selected application, the emission of the transaction code being dependent on the verification of user identity; and

(b) providing to an application operator a connection code recognizable by one of the plurality of user devices, which connection code enables communication between at least one of the plurality of user devices and a server device operable to authorize a transaction of an application running on the server device upon receipt of a transaction authorization request comprising the transaction code.

According to further features in the described preferred embodiments, the connection code is provided to the application operator in exchange for financial compensation.

According to still further features in the described preferred embodiments, transmission of the connection code from a server device to one of the plurality of user devices enables transfer of information from the server device to the user device, which information enables the user device subsequently to transmit to an application server running an application a transaction authorization request which comprises a non-repeating non-guessable transaction code recognizable by the application server as being appropriate for authorizing a transaction of the application.

According to still further features in the described preferred embodiments, the application operator is enabled to utilize the connection code to provide to the one of the plurality of user devices an application code, which application code enables the user device to communicate with a server device running an application, and the connection code is disqualified from further by the one of the plurality of user devices when the application code is provided to the user device.

The present invention successfully addresses the shortcomings of the presently known configurations by providing a method, system and device for authorizing activities and transactions capable of verifying that a user is an authorized user of a device, yet not requiring users' fingerprints or other biometric data to be stored in a central storage system, and not requiring transmission of users' biometric data over a data communication system.

The present invention further successfully addresses the shortcomings of the presently known configurations by providing a method, system and device for authorizing activities and transactions wherein authorization-enabling information transmitted over data communication systems is such that intercepting, copying, and reproducing the communication provides no advantage to unauthorized individuals attempting fraudulent interactions with the device and system.

The present invention further successfully addresses the shortcomings of the presently known configurations by providing a method, system and device for authorizing transactions which uses a peripheral device, operable to verify the identify a user of system, which device is highly portable and entirely self-contained.

The present invention further successfully addresses the shortcomings of the presently known configurations by providing a method, system and device for authorizing business transactions over the telephone or the Internet, yet which protects users, vendors, banks and the credit card companies from fraudulent use of credit card numbers.

The present invention further successfully addresses the shortcomings of the presently known configurations by providing a system for identifying a user and authorizing transactions, which system enables a plurality of application servers to authorize transactions based on secure communication with a user-specific self-contained and highly portable user-controlled peripheral device such as a walled-sized card, the device being operable to verify user identity by examination of biometric user input and being further operable to communicate securely with a plurality of transaction authorizing application servers.

Implementation of the method, system and device of the present invention involves performing or completing selected tasks or steps manually, automatically, or a combination thereof. Moreover, according to actual instrumentation and equipment of preferred embodiments of the method, system and device of the present invention, several selected steps could be implemented by hardware or by software on any operating system of any firmware or a combination thereof. For example, as hardware, selected steps of the invention could be implemented as a chip or a circuit. As software, selected steps of the invention could be implemented as a plurality of software instructions being executed by a computer using any suitable operating system. In any case, selected steps of the method, system and device of the invention could be described as being performed by a data processor, such as a computing platform for executing a plurality of instructions.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is a simplified functional schematic showing information flow through a transaction authorizing system according to an embodiment of the present invention;

FIG. 2 is a simplified schematic detailing functional elements of a transaction authorizing system according to an embodiment of the present invention;

FIG. 3 is a simplified schematic of a transaction code generation and verification system according to an embodiment of the present invention;

FIG. 4 is a simplified schematic of an alternate construction of a transaction code generation and verification system according to an embodiment of the present invention;

FIG. 5 is a simplified schematic of an alternate preferred construction for a user device, according to an embodiment of the present invention;

FIG. 6 is a simplified schematic providing further detail of a communication device incorporated in a user device, according to a preferred embodiment of the present invention;

FIGS. 7a, 7b, 7c and 7d present views of recommended physical formats of a smart card, according to embodiments of the present invention;

FIG. 8 is a simplified flow chart of a method for authorizing a transaction, according to an embodiment of the present invention;

FIG. 9 is a simplified schematic of a multi-application transaction authorization system, according to an embodiment of the present invention;

FIG. 10 is a simplified schematic of a portion of a multi-application transaction authorization system utilizing application codes, according to an embodiment of the present invention; and

FIG. 11 is a simplified flow chart showing a process for utilizing a multi-application transaction authorization system to authorize a transaction, according to an embodiment of the present invention.

### DESCRIPTION OF THE PREFERRED EMBODIMENTS

The present invention is of a device, system and method for authorizing a transaction such as a business transaction, the system comprising a user device providing an non-predictable transaction code upon receipt of biometric input identifying a current user as an authorized user, and further comprising a server device operable to verify that a received code is a valid transaction code provided by a user device, and further operable to authorize a transaction in response to receipt of a valid transaction code. Specifically, the present invention can be used to control business transactions involving credit cards in a convenient and highly secure manner. Preferred embodiments of the invention enable a single user device to provide valid transaction codes to a plurality of applications, which plurality of applications are operable to receive transaction authorizations from a common server device and/or from a plurality of distinct server devices.

The principles and operation of an authorizing system according to the present invention may be better understood with reference to the drawings and accompanying descriptions.

Before explaining at least one embodiment of the invention in detail, it is to be understood that the invention is not limited in its application to the details of construction and the arrangement of the components set forth in the following description or illustrated in the drawings. The invention is capable of other embodiments or of being practiced or carried out in various ways. Also, it is to be understood that the phraseology and terminology employed herein is for the purpose of description and should not be regarded as limiting.

It is to be noted that the term “transaction” as used herein refers not only to financial and business transactions, but also to any sort of action or commerce which might be subject to authorization by an automated authorization system. Thus, for example, the requesting and granting of physical access of a person to a building, and the requesting and granting of log-in privileges of a person to a computer system, are “transactions” as that term is used herein.

The term “application” is utilized herein to refer to any organized set or pattern of behaviors or activities comprising transactions. In typical embodiments an “application” will often comprise a business process or control process comprising automated elements, e.g. comprising a “software application”, yet the term application as utilized herein is not limited to processes of any specific sort. Thus, as the term “application” is used herein, a credit card payment authorization system is an application, a door unlocking system is an application, a computer roll-playing game requiring user identification is an application, and a human system comprising card-based local display of a photograph is an application. In short, the term “application” includes any human and/or automated system comprising transactions requiring authorization.

The term “biometric information” refers to any data gleaned by sensory contact with a user, typically by automated means. The term “biometric sensor” refers to any device useable to detect and optionally also to analyze such information. Fingerprint imaging, voice recognition systems, retinal pattern scans, signature verification, iris scans, hand geometry scans and facial structure scans are examples of biometric sensors, as are other devices operable to observe and report other forms of physical measurement of the body of a user or of the behavior of a user. Any such device is a “biometric sensor” as this term is used herein.

Biometric data typically undergoes some degree of abstraction when being stored or compared by such systems. Thus, a fingerprint identification system might operate by preserving in graphic format an image of a fingerprint, and then using graphics techniques to compare stored images to new images. Yet, a more efficient and more typical use of fingerprint data is to utilize computational techniques to abstract information from the raw image, which abstracted information constitutes a form of description of the image, and to store the abstracted information, rather than the image itself. Comparisons can then be made between stored abstracted information and new abstracted information gleaned from a currently presented image. The term “biometric information” is generally used herein to refer to all levels of abstraction of such information, from the raw data as received from a sensor to highly abstracted descriptive information such as a classification of patterns of lines on a fingerprint into categories of patterns, or a count of the number of junctures at which individual lines of a fingerprint divide into two lines in a “Y” juncture.

The system of the present invention comprises a first device which in a preferred embodiment is a peripheral device, and which is termed a “user device” herein. The system further comprises a second device capable of receiving information generated by a user device, and operable to authorize transactions. In a preferred embodiment the second device is typically enabled to receive information from a plurality of peripheral device, and is operable to authorize transactions for a plurality of users, consequently the second device is termed a “server device” herein. Yet, in an alternative embodiment, the server device may be designed and built to receive information from a single user device, or to authorize transactions of a single user. A server device may be dedicated to a specific application, for example a server dedicated to authorizing transactions of credit cards of a specific credit card company, or a server dedicated to controlling a particular door lock. A server device may alternatively be operable to authorize transactions of a set of related applications, e.g. a server device controlling access to a building and also controlling access to activities therein, or a server device comprising an application operable to verify the age of a customer in a bar and a second application operable to receive payment from that customer. Further alternatively, an individual server device may service a variety of wholly unrelated applications, as in e.g. a service bureau providing transaction authorization services to a city library, a car rental company, a video rental store, and a real estate agency.

In typical use of preferred embodiments of the present invention, a user provides biometric data, such as a fingerprint, to a peripheral user device in order to be identified as an authorized user of the user device, and thereby to gain authorization to receive a product or service controlled by a central server device. The present invention is not, however, limited to this specific context. According to alternative embodiments, a system according to the present invention can be used in any context in which biometric data of an individual is presented to a user device as described hereinbelow, regardless of how the biometric data is obtained. In descriptions of embodiments presented hereinbelow, the term “user”, in the context of “a user of the user device,” is generalized to include any individual whose biometric information is input to, and evaluated by, the user device, regardless of whether his “use” of the system is intentional on his part.

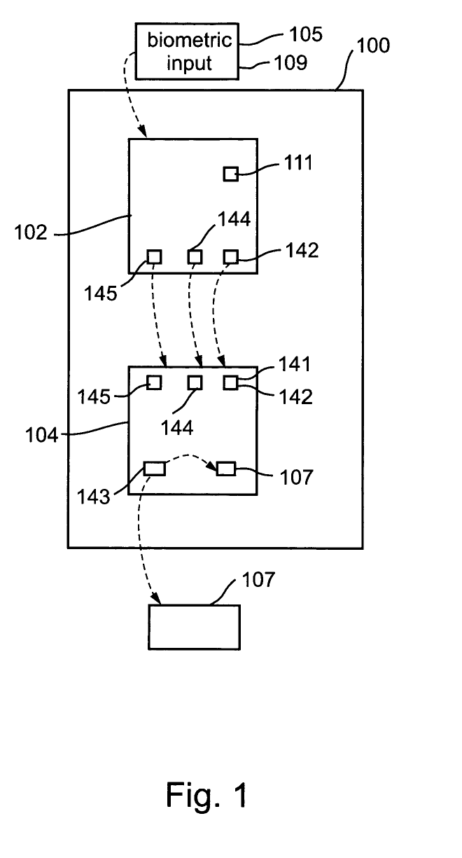

Referring now to the drawings, FIG. 1 is a simplified functional schematic showing information flow through a transaction authorizing system according to an embodiment of the present invention.

System 100 relates a user device 102 and a server device 104. System 100 is useable by a user to achieve authorization of a requested transaction, and provides safeguards against attempted authorization of a transaction by an unauthorized user.

User device 102 is operable to verify that a current user of user device 102 is an authorized user thereof. In preferred embodiments, a current user provides current biometric data 105, such as a fingerprint 109, to peripheral user device 102. User device 102 compares current biometric data 105 to stored biometric data 111 of an authorized user, to determine if the two are sufficiently similar to be considered a match. If, and only if, current data 105 is similar to stored data 111, is a current user considered a verified authorized user of user device 102.

User device 102 is further operable to respond to a successful verification that a current user is an authorized user by providing an authorizing transaction code 142, which may then be communicated to server device 104. Typically, user device 102 issues a transaction code in support of an authorized user's request for a product or service controlled by a central server device 104.

In a preferred embodiment, server device 104 is utilized in conjunction with a plurality of user devices 102. In this embodiment, each transaction code 142 communicated by user device 102 is accompanied by an identification code 144 identifying a particular user device 102 as originator of that transaction code 142. In preferred embodiments, each transaction code is further accompanied by a transaction request 145 specifying the transaction that the user desires to have authorized. For example, in a particularly preferred embodiment described in further detail hereinbelow, user device 102 is formed as a credit card and is useable as a credit card, and a typical transaction communication includes identification code 144 in the form of a credit card number and expiration date, a transaction code 142 provided by user device 102, and a transaction request 145 in the form of a typical credit card transaction request, such as a request for payment of a particular amount to a particular party such as a vendor of goods or services.

Server device 104 is operable to receive a communicated code 141 which is ostensibly a transaction code 142, to examine the validity of received code 141, and to authorize a transaction if received code 141 is valid, that is, if received code 141 is judged to be a transaction code 142 provided by user device 102.

Thus, in the general information flow depicted in FIG. 1, biometric input from a user, entered into system 100 by way of user device 102, eventuates, on condition that the user is an authorized user, in a transaction authorization message 143 created by server 104. Transaction authorization message 143 is typically transmitted to a transaction execution system 107, which executes the requested transaction. Transaction execution system 107 may be embodied within system 100, or alternatively may be external to system 100.

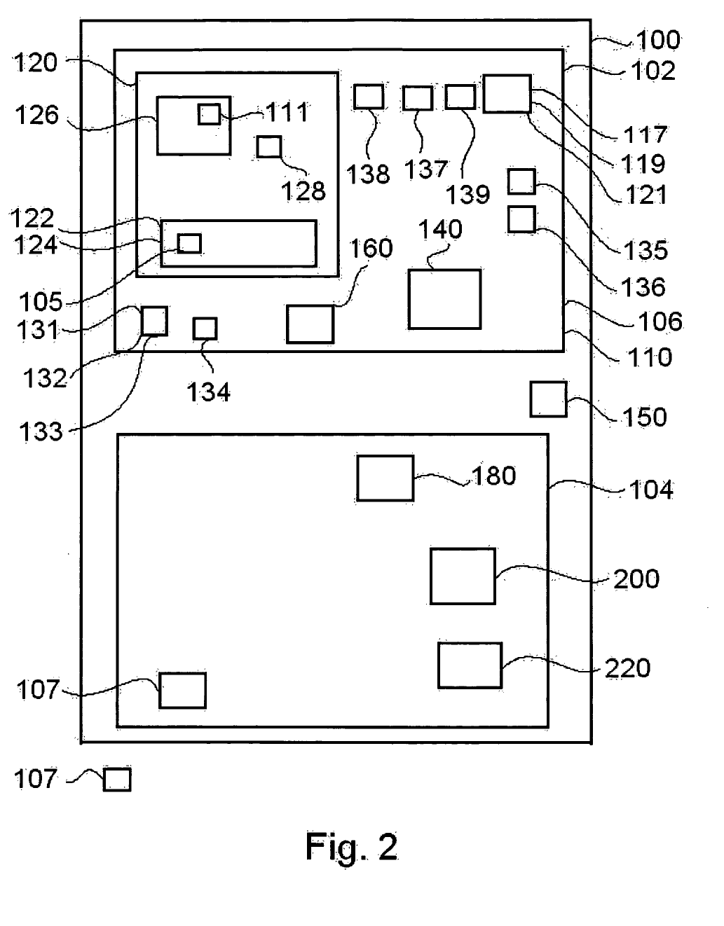

Attention is now drawn to FIG. 2, which is a simplified schematic providing further detail of various functional units of system 100, according to a preferred embodiment of the present invention.

User device 102 includes an identity verification unit 120 operable to receive biometric data of a user and to compare it to previously stored biometric data of an authorized user, to determine if they match, that is, if the two are similar within some defined degree of tolerance of difference.

In a preferred embodiment, user device 102 is formed as a credit card 106 or a smart card 110. Identity verification unit 120 includes a biometric sensor 122, such as a fingerprint sensor 124, for example an optical fingerprint sensor or a capacitance-sensitive fingerprint sensor, for receiving biometric input from a user. Identity verification unit 120 further includes a first data memory 126 usable to store biometric data 111 of an authorized user, and a first processor 128 operable to compare stored biometric data 111 to current-user data 105 based on input received in real time during a execution of a transaction request, from biometric sensor 122. Processor 128 is used to compare stored data 111 to current-user data 105, and to decide if the two are sufficiently similar to be considered a match.

If the two are not considered a match by processor 122, then the transaction authorization process per se stops at that point. In other words, the illegal user of a stolen credit card designed and constructed according to an embodiment of the present invention will not be able to get authorization for a transaction using the stolen card, because that illegal user's fingerprint (or other biometric data) won't be recognized as similar to the stored fingerprint (or other biometric data) of the authorized user who is the legal owner of the card.

It is noted that whereas in a currently preferred embodiment biometric sensor 122 is fingerprint sensor 124, in alternative embodiments biometric sensor 122 is any biometric sensor capable of supplying input which may be analyzed and compared to stored biometric data of an authorized user. In particular, in this and in other embodiments described herein, sensor 122 may include a fingerprint imaging device, a voice recording device, a microphone, a digital camera, a sound-recording device, a voice recognition system, a retinal pattern scanner, a signature verification system, an iris scanning device, a module for measuring hand geometry, a module for measuring facial structure, a module for measuring or describing the geometry of any other part of a user's body, a module for measuring or characterizing a behavior of a user, such a module for measuring a reaction time of a user to a stimulus, and a module for measuring or characterizing a pattern of interaction between sensor 122 and a user, such as a module for measuring or characterizing patterns in a user's input when that user attempts to copy a graphic stimulus presented to the user for copying.

If current user input and authorized user input do match, user device 102 proceeds to communicate this fact. In a preferred embodiment, a transaction code provider 140 is operable to provide a transaction code 142 if, and only if, identity verification unit 120 determines that a current user is indeed an authorized user. Transaction code 142 functions as an intermediary communication code, provided by user device 102 to be received by server device 104. Transaction code 142, provided by transaction code provider 140, is communicated outside of user device 102 by a first communication unit 160. Transaction code 142 may be communicated directly from user device 102 to server device 104, or alternatively transaction code 142 may be communicated to server device 104 through a variety of indirect pathways, as will be further described hereinbelow.

Server device 104 includes a second communication unit 180, operable to receive communicated codes 141 which are ostensibly transaction codes 142, and, optionally, to further receive user device identification codes 144 and transaction requests 145. A transaction code verifier 200 is operable to verify that a received code 141 is a valid transaction code 142. Server device 104 further includes an authorizer 220 operable to authorize a transaction upon receipt of a transaction request accompanied by a transaction code 142 whose validity has been verified by transaction code verifier 200. Typically, authorizer 220 authorizes a transaction by sending a transaction authorization message 143 to a transaction execution system 107 operable to execute a requested transaction. In one preferred embodiment, transaction execution system 107 is external to system 100. In an alternate preferred embodiment, transaction execution system 107 is included in system 100.

Transaction code 142 is communicated between user device 102 and server device 104. Communication between the two may be direct, as in a leased phone line, or it may be quite indirect, as in the case where user device 102 communicates transaction code 142 visually to the user, who then communicates it via face-to-face conversation, by phone or by email to a third party such as a vendor of goods and services, which third party then communicates it to a credit card company as part of a request for payment, which credit card company communicates it to server 104 in a request for authorization of the requested payment. In a preferred embodiment communication between user device 102 and server device 104 is facilitated by an intermediate device such as a card reader 150. Card reader 150 may be any device operable to communicate locally with user device 102 and also operable to communicate remotely with server device 104. Thus card reader 150 may interact with user device 102 by means of digital communication, using physical electronic contact with device 102, local radio-based or infra-red communication, or an similar communication technology linking reader 150 with device 102, or by analog or analog/digital hybrid communication, such as using a “swipe” technology to read a magnetic pattern presented by device 102 embodies as a card, or using a camera in reader 150 to read a one-dimensional or two-dimensional bar-code pattern presented by a graphical display integrated in device 102, etc. Card reader 150 can communicates with server 104 through direct wire connection, LAN or WAN, short range or long-range radio communication, infra-red communication, telephone dialup, internet connection, or any similar communication means. In a particularly preferred embodiment card reader 150 is a peripheral device connected to a computer with internet connection, reader 150 being equipped for IR or local radio communication with user device 102 embodied as a smart card, enabling users to present their device 102 to a reader 150 which communicates to an application server through an internet connection. It is further noted that the communication functionality here described as included in reader 150, and in particular capabilities of radio communication or other direct or indirect means for communicating with server device 104, may also be embedded in user device 102, thereby enabling device 102 to communicate remotely with server 104 without need of an intermediary device.

It is noted that in alternative embodiments, user device 102 may provide a useful service when utilized on a stand-alone basis, that is, when utilized without transmitting a transaction code 142 to be received by server device 104. Thus, in an embodiment wherein user device 120 is implemented, for example, as an employee's identity card, or a national identity card, or as some other form of personal identity card, first communication unit 160 is operable to communicate outside of user device 120 (e.g., by an appropriate display, such as a digital LCD display) the fact that there exists a match between current user input and authorized user input, thereby demonstrating to any interested party that the holder of such an identity card is indeed the authorized holder of that identity card, and not some other person. Alternatively, device 102 may be enabled to display user-identifying information (e.g. an ID card including photograph) without biometric validation of user identity, so as to provide at least minimal functionality in that case that biometric identification of an authorized user should fail for some reason.

Embodiments of user device 102 may comprise various additional hardware elements providing flexibility and convenience. In a preferred embodiment, user device 102 includes a power source 117 such as a battery 119 or a photocell 121 to provide electrical energy to first processor 128 and first data memory 126. Battery 119 is preferably a replaceable battery, yet battery 119 may also be a rechargeable battery connectable to an outside electricity source for recharging. User device 102 may also comprise an on-board energy source 131 such as a kinetic charger 132 operable to charge battery 119 by generating electricity from kinetic energy of movement of device 102, or a fuel cell 133. Device 102 may also comprise a second battery 134, optionally rechargeable, so that on notification by device 102 of low power in battery 119, battery 134 can maintain power while battery 119 is replaced.

First data memory 126 is preferably a memory such as a flash memory capable of retaining stored information even when temporarily disconnected from power source 117. Alternatively, power source 117 will include connections enabling to provide external power to first data memory 126 during replacement of battery 119.

Device 102 may comprise a clock 135 or counter 136, either or both of which may be used for limiting authorized access to an application to predefined time period or predefined number of accesses.

Device 102 may comprise a sound generator 137, facilitating communication with application software on a server device 104. Thus, sound generator 137 can communicate with a server 104 through an audio telephone connection, or communicate with a user by emitting a beep or other sound message when prompted to do so by a message from an application running on server 104.

Device 102 may comprise radio frequency communication equipment 138 (e.g. radio sender/receiver, antenna) useable as an element in a communication link between user device 102 and server device 104.

Physical contact elements 139 (push buttons, touch screen) may serve as communication devices enabling communication between a user and device 102. Physical electronic contacts on the card may serve as a data pathway when a card is brought into physical contact with a server peripheral or with an intermediary communication device such as a card-reading device 150 used to link user device 102 and server 104. Optionally, user device 102 may be integrated into a device comprising unrelated or only partially related functionality. For example, user device 102 might be integrated into a Personal Digital Assistant, or a cell phone, or a portable music player.

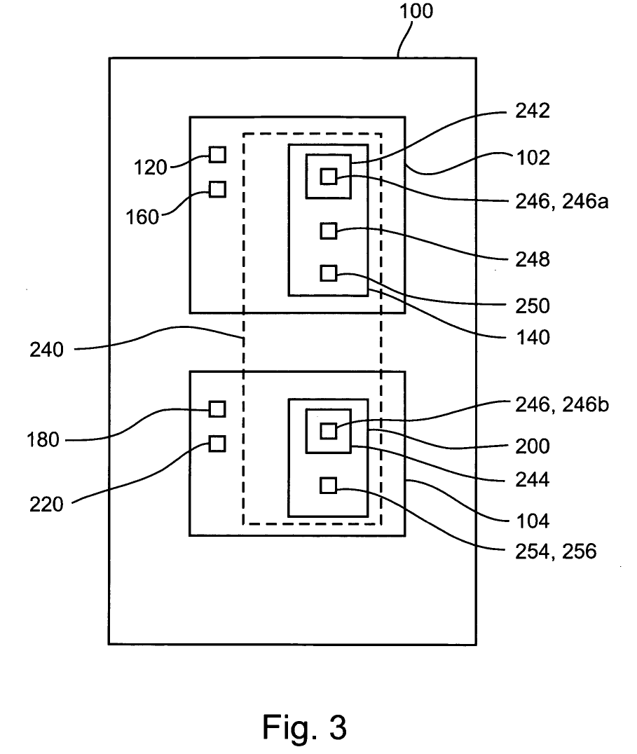

Attention is now drawn to FIG. 3, which is a simplified schematic of a transaction code generation and verification system according to a preferred embodiment of the present invention.

Since transaction code 142 may be communicated indirectly to server device 104, it is highly desirable that the transaction code 142 be secure in two ways. First, it is desirable that transaction code 142 not be easily forged, predicted or simulated by an outside party, such as a sophisticated hacker. Second, it is desirable that transaction code 142 be such that subsequent reproduction and re-use of a previously used transaction code 142 will not profit an unauthorized user attempting to spoof the system.

Presented is a code generation and verification system 240 which comprises a transaction code provider 140 included in user device 102, and a transaction code verifier 200 included in server device 104.

Since it is desirable that transaction code 142 be such that no unauthorized user or system can easily predict it or simulate it, transaction code 142 must be a non-predictable code, in the sense that it cannot be predicted by an outside person or system, such as a hacker.

According to a preferred embodiment of the present invention presented in FIG. 3, system 100 is provided, during an initialization phase, with a set of digital codes 246. Digital codes 246 may be communicated from server device 104 to user device 102 during an initialization phase of operation, or provided to user device 102 through some other means. Set 246 is a set of individually selectable digital codes useable as transaction codes 142. The digital codes comprising set 246 are random digital codes such as may be gleaned from analyses of random natural processes such as radio noise from cosmic sources. Alternatively, set 246 may be constructed of what is known in the art as “pseudo-random” codes, which are digital sequences generated by mathematical algorithms useable to produce series of digital codes which, while not necessarily truly random, are certainly unpredictable for any practical purposes. (The RND functions of standard computer languages running on PC computers produce pseudo-random numbers of this sort.)

The size of set 246 is preferably sufficiently large to exceed the number of authorized transactions likely to be requested by authorized users during the expected lifetime of user device 102. For example, in a preferred embodiment in which user device 102 is implemented as a credit card or smart card, set 246 would preferably contain between 1000 and 10000 codes, and most preferably about 3000 codes, this being a number expected to exceed the number of requests for transactions expected to be made during the physical or legal life of a credit card in a typical population of credit-card users. Of course, the size of set 246 may be optimized at other sizes for other populations of users, in other uses, or in other embodiments. The size of set 246 may also be artificially limited for commercial purposes, as when a user purchases a time-limited or quantity-limited number of authorizations from a supplier of device 102 or from a supplier of goods or services whose application utilizes transaction authorization system 100.

The number of digits included in each code of set 246 is preferably sufficiently large to prevent any likelihood of an unauthorized user hitting on a legitimate transaction code 142 just by guessing. Thus, each transaction code 142 will preferably include at least 6 decimal digits and preferably 8 or more decimal digits, and most preferably between 10 and 20 digits.

A first copy of set 246, designated 246a, is stored in a first code memory 242 included in transaction code provider 140. Transaction code provider 140 provides a transaction code 142 by operating a selector 248, which may be a processor or other device, to select a next transaction code from among the codes stored in first code memory 242 as set 246a. The selected code is then passed to first communicator 160, for use in furthering a transaction.

Transaction code provider 140 also operates a first disqualifier 250 to disqualify the selected code 142 from being re-selected in the future. That is, first disqualifier 250 removes the selected transaction code 142 from set 246a.

A second copy of random code set 246, designated 246b, is stored in a second code memory 244 included in transaction code verifier 200 of server device 104.

Transaction code verifier 200 includes a code tester 254 for testing a received code 141 to determine if received code 141 is a transaction code 142. In the embodiment presented in FIG. 3, code tester 254 is a code searcher 256, operable to search among the codes of set 246b to determine if received code 141 is among them.

If received code 141 is not found within set 246b, then received code 141 is not a legitimate transaction code 142, transaction code verifier 200 does not validate received code 141, and server device 104 does not authorize the requested transaction.

If received code 141 is found within set 246b, then transaction code verifier 200 does validate received code 141, and informs authorizer 220 that a valid transaction code 142 has been received, whereupon authorizer 220 authorizes a transaction. Optionally, authorizer 220 may be further operable to utilize additional information, such as a user's credit status and bank balance, to further determine whether to authorize a transaction.

If received code 141 is found within set 246b, then transaction code verifier 200 also operates a second disqualifier 260 to disqualify the received transaction code 142 from being re-validated in any future transaction request. That is, second disqualifier 260 removes the selected transaction code 142 from set 246b.

Disqualifiers 250 and 260 protect system 100 from abuse by unauthorized users who become aware of the details of an authorized transaction. In general, to prevent subsequent re-use of a transaction code 142 (e.g., by a hacker), transaction code provider 140 is designed and constructed to issue any particular transaction code 142 only once. That is, a particular code, once issued by a user device 102, will not be issued again by that user device 102. In the embodiment presented in FIG. 3, transition codes 142 are selected from a finite set of codes 246a, and any code so selected is removed from set 246a so that it cannot again be selected. (Preferably, set 246 contains no duplicate codes.)

Similarly, server 104 is designed and constructed such that it will not validate a particular transaction code, received from a particular user device, more than once. Server device 104, having authorized a transaction based on receipt from a particular user device 102 of a particular transaction code 142, will not again honor that transaction code 142 if it is presented subsequently in support of another transaction request from the same user device 102. Thus, even should an eavesdropper or a hacker gain access to all the details of a transaction, including identity of the user, the identity of his user device (e.g., the number and expiration data of his credit card), and a transaction code 142 produced by his client 102 and recognized by server 104, server 104 will ignore (or optionally take further defensive steps against) any further attempt to re-use that particular transaction code 142 to achieve authorization of an additional transaction.

Thus, in preferred embodiments of the present invention, only an authorized user can use user device 102 to initiate a transaction request, and only an authentic transaction code provided by user device 102 will be validated by server device 104 and lead to authorization of the requested transaction.

In a preferred embodiment, care is taken to construct user device 102 using technologies such as smart card construction technologies well known in the art, to render difficult the unauthorized reading of memory devices of user device 102, or other deconstruction or reverse engineering of user device 102 by an unauthorized user with criminal intent.

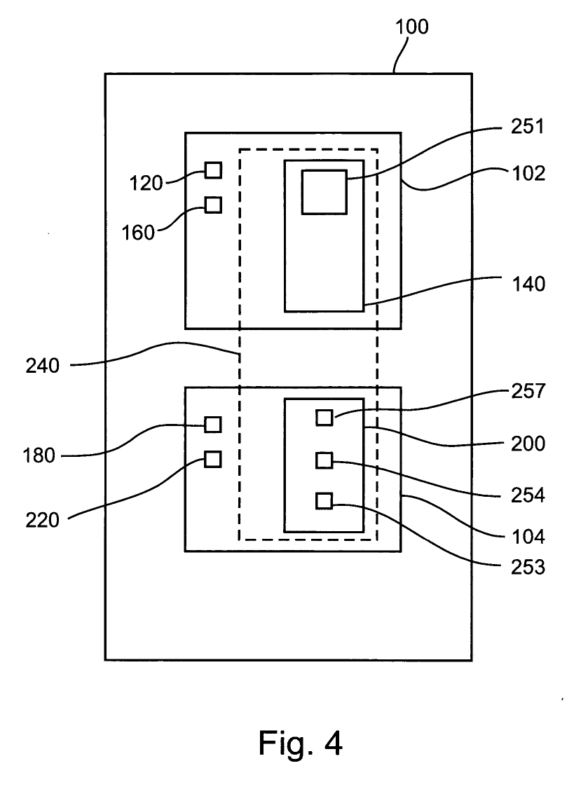

Attention is now drawn to FIG. 4, which is a simplified schematic of an alternate construction of a transaction code generation and verification system 240 according to a preferred embodiment of the present invention.

A first algorithmic random code generator 251 is included in transaction code provider 140, and a second algorithmic random code generator 253 is included in transaction code verifier 200. In a preferred embodiment, algorithmic random code generators 251 and 253 are pseudo-random code generators similar to those provided by standard programming languages running on PC computers, wherein a “seed” in the form of an initial numerical value is useable by a computational algorithm to produce a substantially random string of digital codes. The string of codes so produced is invariant, in that given a particular algorithm and a particular seed, such a code generator will produce an identical string of digital codes every time. Yet, the produced codes are non-predictable in that an outsider, not having specific knowledge of both the algorithm and the seed, cannot predict the code sequence which will be generated.

In the preferred embodiment presented in FIG. 4, generators 251 and 253 are initialized to a same algorithm and seed. Information required for this compatibile initializations of code generators 251 and 253 (i.e. details of the algorithm selection and/or algorithm parameters and/or seed values to be used) is generally referred to in the following disclosure and in the claims section of this application as the “rule” or “rules” by which digital codes are to be generated. In preferred embodiments, such initialization is effected by communication of a rule from server device 104 to user device 102 during an initialization phase of operation. Other means for compatible initializations of generators 251 and 253 may also be used.

To produce a next transaction code 142, first algorithmic random code generator 251 is operated to produce a sequence of digits. Each time generator 251 is operated, it produces the continuation of that sequence, thus guaranteeing that no code 142 is issued more than once, except as a highly unlikely random happenstance.

In the embodiment presented in FIG. 4, code tester 254 tests whether a received code 141 is a transaction code 142 by operating generator 253, from its initial seed value, for some finite maximum number of iterations, e.g., up to 3000 iterations. The code generated by each iteration of operation of generator 253 is compared to receive code 141. If no match is found after a predetermined maximum number of iterations, code 141 is not validated.

If a match is found, the iterative code generation process ceases and tester 254 checks in a used-code memory 257 to determine if the matched code 141 has already been used. If so, code 141 is not validated. If not, code 141 is validated as a valid transaction code 142, and is stored in used-code memory 257 to insure that it cannot be used again.

In the embodiment presented in FIG. 2, user device 102 is formed as credit card 106, a smart card 110, or a similar light and portable object. Sensor 122 is designed and constructed incorporated in the card, and all processors and memories are on the card as well.

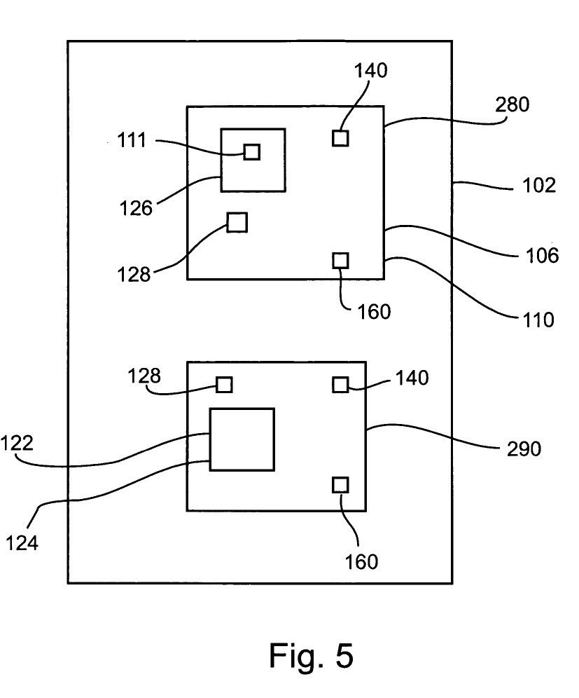

Attention is now drawn to FIG. 5, which presents an alternate preferred construction for user device 102, wherein user device 102 comprises two physically separate devices, and various functional elements of user device 102 described hereinabove are distributed among those elements. FIG. 5 presents an example in the form of a preferred embodiment of the present invention, wherein user device 102 is implemented as a portable user device 280 and a stationary user device 290.

In a particularly preferred embodiment of the present invention, portable device 280 is a credit card 106 or smart card 110, having a first data memory 126 operable to store biometric data 111 of an authorized user. Stationary device 290 includes biometric sensor 122 such as fingerprint scanner 124.

In one preferred construction, processor 128 is included in stationary device 290, and biometric data from sensor 122 is compared to stored data 111 transmitted from portable user device 280 to stationary device 290. In an example of this construction, portable device 280 is a credit card 106 having a magnetic strip storing the stored information, and stationary device 290 includes a magnetic strip reader from reading the stored information.

In an alternative preferred construction, portable device 280 is a smart card 110 having a memory, and stationary device 290 is a smart card reader. In this construction, processor 128 is included on portable device 280, and biometric data from sensor 122 is transmitted from stationary device 290 to portable device 280, where the comparison takes place.

The examples here presented are intended to be illustrative but not limiting. It is clear that various other placements and combinations of the essential elements of user device 102 are possible. Transaction code provider 140 and first communicator 160 may be on either portable device 280 or stationary device 290. It is noted that the essential characteristics of the embodiment here described are unchanged if portable device 280 is in fact designed and constructed as a non-portable unit, or if stationary device 290 is in fact embodied in a form which is portable.

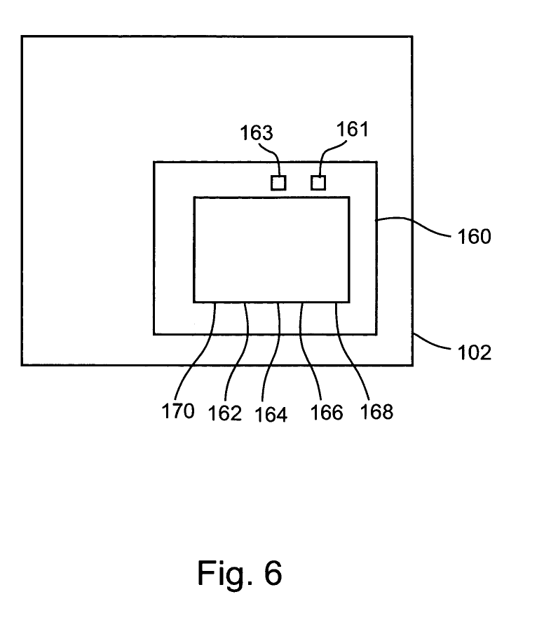

Attention is now drawn to FIG. 6, which is a simplified schematic providing further detail of a communication device 160, according to a preferred embodiment of the present invention.

It is noted that communication device 160 may be, or include, data communication devices of any sort, including, but not limited to, a radio-frequency communication device, an optical communication device, an infra-red communication device, and an auditory communication device emitting sounds either audible or inaudible to the human ear. Alternatively, communication device 160 may include a machine-readable memory 161 and a set of connectors 163 enabling machine readable memory 161 to be read by a reader external to user device 102.

In a preferred embodiment, first communication device 160 is a graphic display device. FIG. 6 provides details of a user device 102 in which communication device 160 is implemented as a graphics display screen 162. Graphics display screen 162 may be implemented as an LCD display 164, or as a light-emitting display 166 such as a plasma display 168 or an organic-compound display 170 incorporating light-emitting organic compounds.

In a preferred embodiment, display screen 162 is enabled to display transaction code 142 in a human-readable digital display, in a machine-readable barcode display, in a machine-readable two-dimensional barcode display, in a font readable both by humans and by machines, and in a machine-readable time-dependant (e.g., flashing) display. In this embodiment, a user, having provided a fingerprint or other biometric input to user device 102, is enabled to read transaction code 142 directly from graphics display screen 162. Alternatively, transaction code 142 displayed on graphics display 162 in machine readable format can be read automatically by an appropriate reader, such as the barcode reader of a supermarket checkout counter, which is then optionally enabled to transmit transaction code either directly or indirectly to server device 104. In an alternative embodiment, machine readable output can be produced by a sound generator 137, as mentioned hereinabove with reference to FIG. 2.

To prevent misuse of device 102 by an unauthorized user, communication of transaction code 142, e.g., display of transaction code 142 on display 162, is preferably limited in time, preferably to two minutes or less, and most preferably to about 30 seconds or less. Thus, a user can easily obtain a transaction code and supply that code along with his credit card number to a vendor of goods and services, yet can be confident that no unauthorized user can obtain a transaction code from his card once that code has disappeared from graphics screen 162.

In a currently preferred embodiment, an authorized user obtains transaction code 142 by the simple expedient of pressing his finger to a fingerprint sensor on his credit card, after which the authorized user can read a transaction code directly off the card so as to provide it to a vendor over the telephone or over the Internet, or the authorized user can cause it to display in a form such as a barcode which is directly readable by a store checkout counter. Each time the authorized user presses his finger to the fingerprint sensor, a new and unique transaction code 142 is produced and communicated (e.g., displayed). Further, the authorized user can be confident that no unauthorized user will be able to obtain any additional transaction codes from his card, since no unauthorized user can provide authorized user's biometric input. Further, the authorized user can be confident that a transaction code once used cannot be used again for an additional transaction.

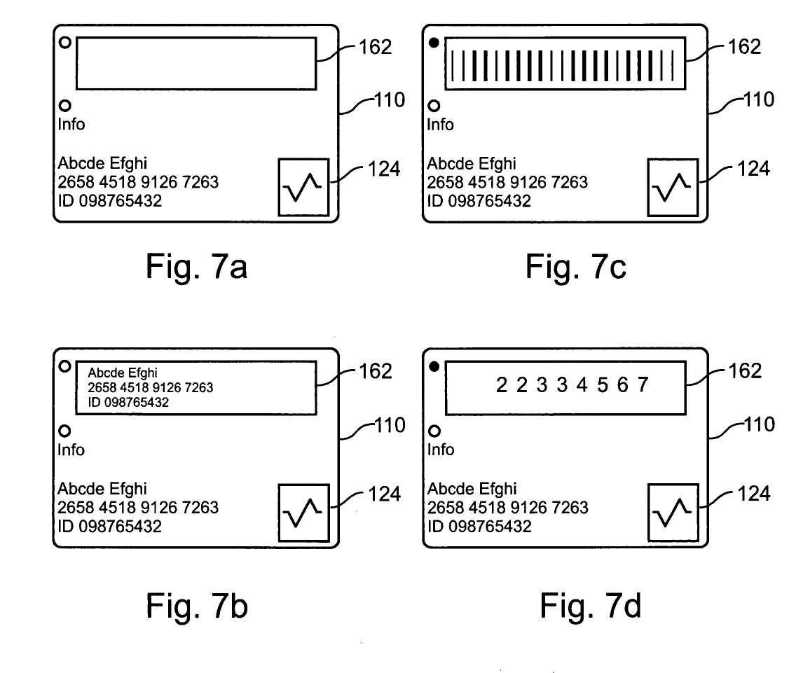

FIG. 7 presents several views of a recommended format of an embodiment of the present invention, wherein user device 102 is formed as a smart card 110 utilizing, as a communications device 160, a graphics display screen 162. Graphics display 162 is alternatively shown as (a) blank, (b) displaying user's name and credit card number and an identification number such as a bank branch and account number (c) presenting a number, including transaction code 142 and optionally including a credit card number, in machine-readable barcode format, and (d) presenting a number, in including transaction code 142 and optionally including a credit card number, in human-readable format. Graphics display screen 162 may alternatively be designed in an enlarged format and utilized to present, additionally, graphic information such as a stored identity photograph of the card owner.

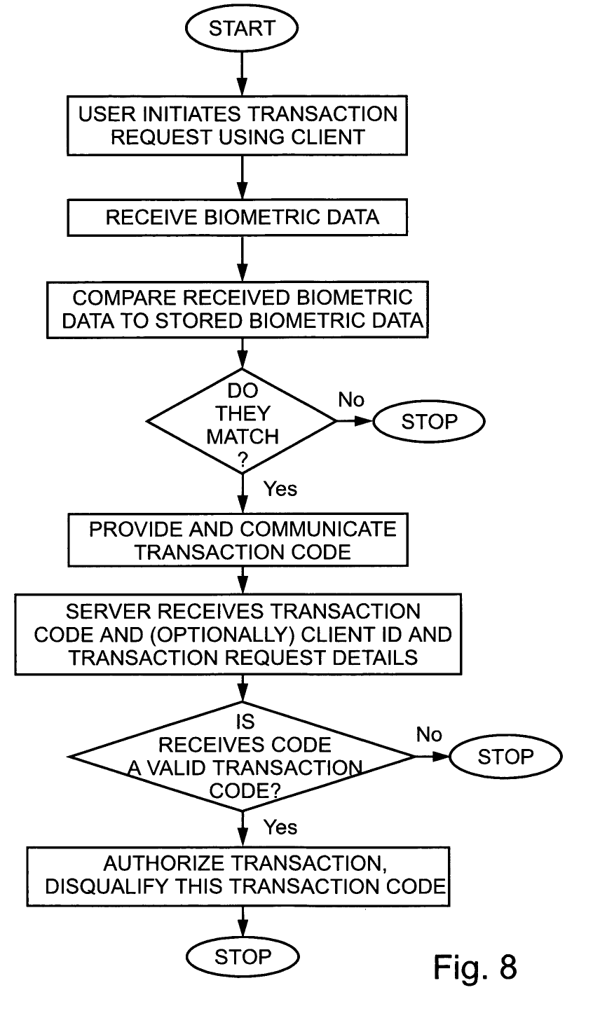

FIG. 8 is a simplified flow chart summarizing a method for authorizing a transaction, according to an embodiment of the present invention.

A transaction request is initiated by a user, who provides biometric input to a user device 102. An identity verification unit of a user device compares received biometric input 105 to previously stored biometric data 111 of an authorized user. If the two sets of biometric data are sufficiently similar, user device 102 provides a transaction code 142 which is communicated outside the user device. If biometric input provided by a user is not sufficiently similar to stored biometric data of an authorized user, then no transaction code is provided.

Provided transaction code 142 may be communicated directly to a user or directly to server device 104, or transaction code 142 may be communicated to a third party such as a supplier of goods and services to whom the user wishes to make a payment, and who will in turn communicate it, directly or indirectly, to server device 104.

When a transaction request accompanied by a code is received by server device 104, the received code is tested to determine if it is a valid transaction code for the user device which purportedly supplied it. If it is, then server 104 authorizes the requested transaction. If it is not, server 104 does not authorize the requested transaction. Each validated transaction code is disqualified from being re-validated in future transactions.

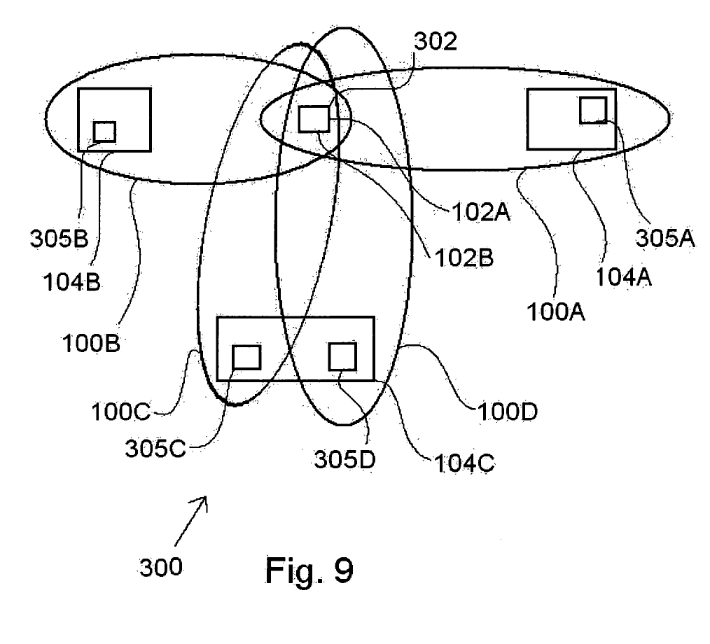

Attention is now drawn to FIG. 9, which is a simplified schematic of a multi-application transaction authorization system 300, according to an embodiment of the present invention.

The discussion hereinabove has concentrated on contexts wherein user device 102 and server device 104 are together operable to authorize transactions with respect to single applications, for example a credit card application or a door lock application. However, as discussed in the background section hereinabove, it is advantageous for a user device similar to user device 102 to be operable to interact with one or more server devices to provide transaction authorization services with respect to a plurality of applications. Such a system provides advantages of improved portability, distributed cost, and the possibility of combined operations (e.g. verifying permissibility of a transaction, and then paying for that transaction).

FIG. 9 presents such a multi-application transaction authorization system in simplified schematic form. A multi-application user device, here designated device 302, functions as user device 102 (as described hereinabove, and here designated device 102A) with respect to a first application 305A running on a server device 104 (here designated device 104A). Device 302 also functions as a user device 102 (here designated 102B) with respect to a second application 305B running on a server device 104B. Device 302 also serves as user device 102C with respect to an application 305C and as user device 102D with respect to an application 305D, both running on a server device 104C. Thus, the combination of device 302 and server 104A constitute a system 100 as defined hereinabove (here design system 100A). The same physical device 302 together with server 104B constitutes a system 100B. Device 302 together with server 104C running application 305C constitutes a system 100C, device 302 together with server 104C running application 305D constitutes a system 100D, and so on for any number of applications. Thus, a smart card or other device 302, comprising features of user device 102 defined hereinabove, can provide biometrically controlled coded transaction authorization requests to, for example, a first credit card application running on server 104A, an employee identification system running on server 104B, a tax application, library card application, driver's license application and a senior citizen benefits application all running on a local government server 104C, a supermarket quantity-purchase discount card running on a server at the local supermarket, and so on.

Multi-application user device 302 comprises the features and functions, including optional and alternative embodiments, described hereinabove with respect to device 102 and presented in detail in FIGS. 1-8. In addition, device 302 comprises means for delivering the described user device functionality in relation to a plurality of applications running either on a single server or on a plurality of server devices.

With respect to each application, device 302 functions as device 102. Initialization of transaction codes 142 and operation of the user-device/server-device combination to authorize transactions proceeds as described hereinabove, with a few modifications, described hereinbelow, to ensure independence of applications one from another, and to identify, where appropriate, each communication between user device and server device as relating to a specific selected application, and no other. In a preferred embodiment, applications do not have transaction codes in common, and each application does have a unique identifying code which serves to distinguish it from other applications, and which serves to distinguish communications concerning it from communications concerning other applications.

In a preferred embodiment, initialization of multi-application user device 302 proceeds in two stages. A first stage might be termed “personal initialization”, or “user initialization”. In this stage a user, having received and unpacked a new device 302 (preferably embodied in card format), presents a sample of his biometric input information (e.g. a fingerprint) to device 302, which records that information. This is preferably a one-time process, by which device 302 is personalized to that individual who initially provides the biometric information. Device 302 cannot thereafter be used by any other user, and will not “recognize” any other person.

A second initialization stage, which might be termed “application initialization”, is iterative: it may be repeated multiple times, once for each application of the plurality of applications with which device 302 is to interact. During application initialization an application 305 provides to device 302 a set of one-time transaction codes 142, specific to that particular application 305. The one-time transaction codes 142 thus supplied to device 302 will subsequently be sent by device 302 to an application server 104 serving that particular application, when requesting authorization of a transaction within that application.

Thus, each particular application 305 is responsible for supplying its own transaction codes during initialization and for recognizing those codes during authorization of transactions. Preferably there is no connection nor relationship between codes supplied and recognized by a first application and codes supplied and recognized by a second application. As described hereinabove with respect to device 102, an application may supply a set of transaction codes (as discussed in detail hereinabove, with particular reference to FIG. 3), or alternatively an application may supply a rule for generating transaction codes (as discussed in detail hereinabove, with particular reference to FIG. 4).

In an optional commercial use, each application 305 can be made to supply a limited number of transaction codes, requiring users wanting additional transactions to purchase additional codes, and/or applications can limit transaction code issuance to a pre-determined time period, requiring user wishing to extend their time of use to purchase additional time from the application supplier. In alternative embodiments, an application 305 may supply multiple transaction codes during initialization, or may alternatively supply only a single code, and then re-supply a new transaction code for future use as part of each successful transaction (that is, supplying a next transaction code each time a previous transaction code is used in a successfully authorized transaction).

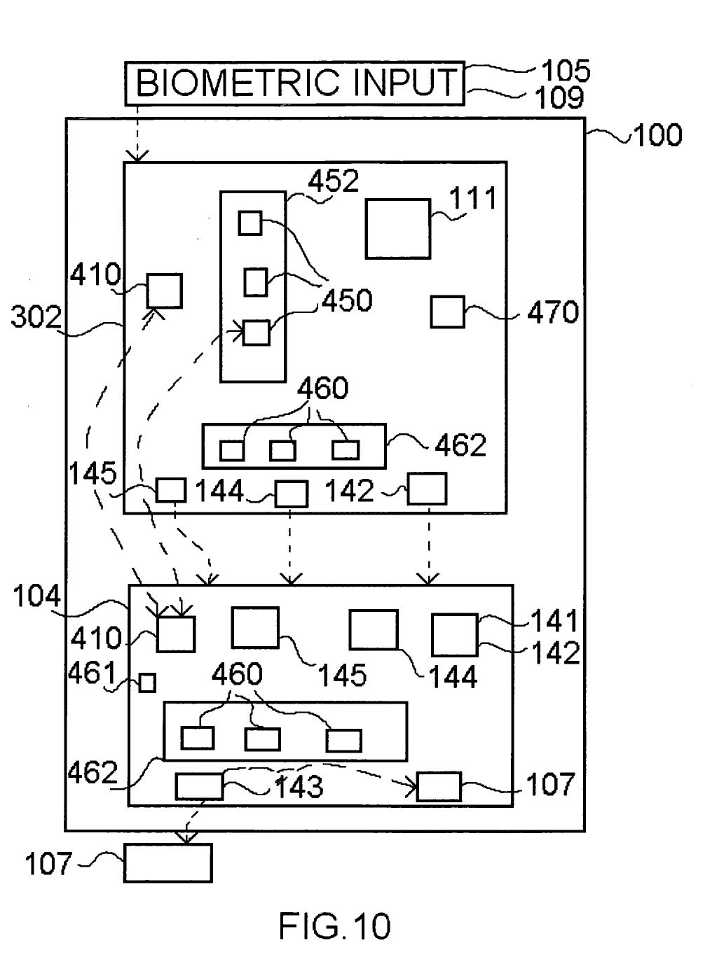

Attention is now drawn to FIG. 10, which presents a simplified schematic of a portion of a multi-application transaction authorization system utilizing application codes, according to an embodiment of the present invention.

As previously described, each transaction authorization request preferably comprises a transaction code 142 communicated by user device 102/302, an identification code 144 identifying a particular user device 102/302 as originator of that transaction code 142, and, in preferred embodiments, each transaction code is further accompanied by a transaction request 145 specifying the transaction that the user desires to have authorized. In the case of multi-application device 302 each transaction request is further accompanied by an application code 410. Each application code 410 is specific to a particular application, and is sent as a part of each message from application server to user device 302, and as part of each message from user device 302 to an application server. Thus, after initialization by multiple applications, a memory (such as code memory 242) on board device 302 stores a set of application codes, and, for each application codes, either a set of useable transaction codes 142, or a seed or rule for generating useable transaction codes.

In a preferred embodiment of a transaction authorization system comprising multi-application user devices 302, application codes are standardized across a population of applications, users, and user devices. Thus, in this relatively simple embodiment, a particular application (e.g. a library card for a particular library, and credit card issued by a particular bank, etc.) has the same application number across all user devices. Application codes are preferably issued by a single source (such as the supplier of devices 302) so as to avoid possible conflict among applications. Additional methods for allocating application codes are discussed hereinbelow.

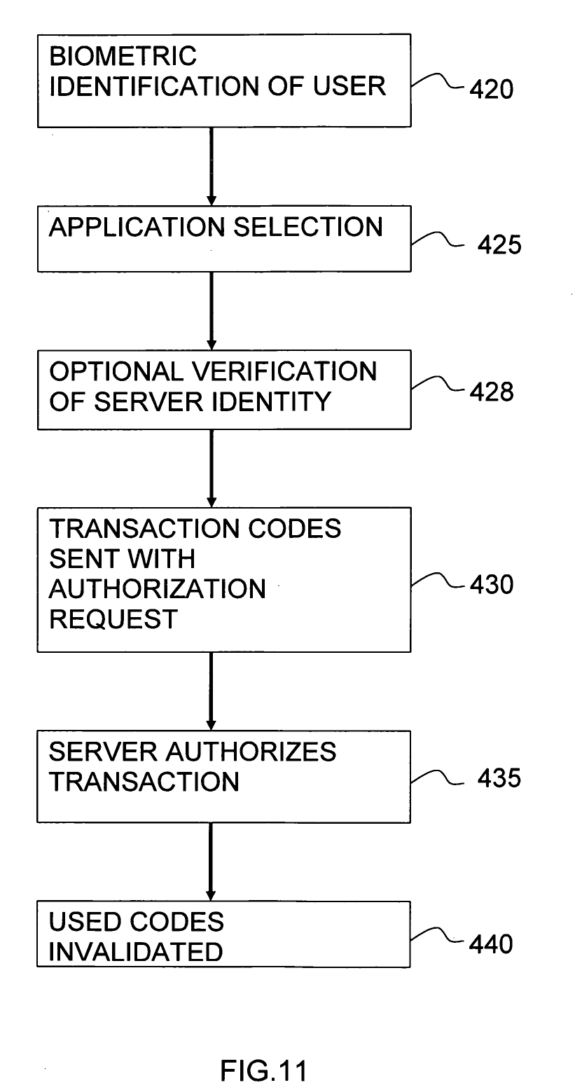

Attention is now drawn to FIG. 11, which is a simplified flow chart showing a process for utilizing a multi-application transaction authorization system to authorize a transaction, according to an embodiment of the present invention.

At step 420, user device 302 verifies the identify of a user, by comparing biometric input provided by that user with biometric input previously stored in device 302 during user initialization of device 302.

At step 425, an application is selected.

In an optional step 428 discussed in detail hereinbelow, server identity may be verified.

At step 430, device 302 directly or indirectly sends an appropriate transaction code to a selected application server 104. Step 430 optionally includes additional message content identifying a specific device 302 and providing details of a specific transaction which the user desires to have authorized.

At step 435, selected application server 104 verifies that the received code is an appropriate transaction code for that application, authorizes the transaction, and preferably informs device 302 that the transaction has been authorized.

At step 440, both device 302 and server 104 invalidate the transmitted transaction code, so that it cannot be used a second time to authorize a subsequent transaction.

The above listed steps will now be reviewed in further detail.

With respect to step 420, in a preferred mode of use, biometric identification of a user is time-limited, preferably to a period of about a minute or two, or whatever delay proves convenient in use. Thus, a user provides biometric input, is recognized by his device 302, and then has a limited period of time in which to initiate authorization of a transaction through communication with a remote application server (e.g. through a card reader or other device). After that time limit expires, device 302 will not authorize a transaction unless the user's biometric input is re-submitted. Thus, a lost/stolen device 302 is useless to anyone but it's owner.

Steps 420 and 425, and components thereof, may be initiated in a variety of orders. In typical use, for example paying at a store using a credit card comprised on device 302, step 420 precedes step 425. A user typically initiates use by providing biometric input (e.g. his fingerprint) to device 302, and then by selecting an application he wishes to address. Alternatively, a user might initiate activity by supplying biometric input, followed by a period during which device 302 passively awaits input from an application (represented by e.g. a card-reading peripheral device), which application identifies itself.

Once an application is selected, either by user input or by input supplied directly by an application server or indirectly by an application server peripheral such as a card reader 150, device 302 then selects and emits a transaction code appropriate for the selected application.

Alternatively, activity might be initiated by an application. An application server might address a user, either directly or through a peripheral in the user's environment, or even through notification delivered through device 302. For example, a device 302 provided with radio receiver and sound generator might inform a user that he is in range of the application server serving a particular application, and that he is requested to identify himself (e.g.: “you are now entering a restricted area. Please activate your ID card”).

Thus, selection of an application may be initiated by a user or by an application. Selection may also be initiated by a combination of these, as would be the case, for example, when a user enters a real or virtual clubhouse, is presented with a list of available activities, and selects one, whereupon his device 302 and an application server serving the selected application then proceed to authorize his participation therein.

Thus, a user might initiate a transaction by presenting biometric input (e.g. fingerprint) to a device 302, and then initiate a dialog with a server 104 by any practical means of communication built into the user interface of device 302. For example, a user might select an application by pressing a button or a sensitive portion of a touch screen, by using a pointing device to select from a menu, by appropriately timed response to a series of visual cues, by programmed voice command, etc., whereupon device 302 might then attempt to engage the selected server 104 through an appropriate radio or IR communication link, or by presenting an appropriate transaction code bar-code pattern on a display screen, or by any similar means. On the other hand, an application server (or card reader serving as application server proxy) might detect the presence of device 302 through radio-frequency communication, identify itself to device 302 through broadcast of its application code, and wait for a transaction code response from device 302, which response would be provided by device 302 after receipt of appropriate biometric input from a user. Note that in both cases presented in this paragraph, the transaction authorization process comprises a step in which an application is identified and an application code communicated, a step in which a transaction code appropriate to that identified application is selected and emitted by device 302 and is communicated directly or indirectly to the application server, and a step in which the application server authorizes the transaction.

In a particularly preferred embodiment, device 302 is entirely passive until activated by receipt of biometric input from a user. Following validation of that user's identity, device 302 is then active for a programmed lapse of time, during which time device 302 may receive further input (e.g. selection of an application and request for a transaction code) from a user, and/or may be open to an automatic dialog from an application server communicating with device 302 directly or through a peripheral device such as a reader 150. Such a dialog may take place because a user initiates contact between device 302 and application by passing his device 302, formed as a card, through a card reader. Similarly a user might initiate a dialog by giving his name to an application server over the internet. Similarly, a dialog might be initiated by a reader (e.g. a card reader with a radio link) detecting presence of device 302 in its vicinity. Typically, an application server would then respond by sending its application code to device 302, thereby identifying itself to device 302. Optionally, an application server might choose one of a variety of application codes to device 302, e.g. depending on what selection of services a user has subscribed to.

In most embodiments, it will be preferable for the application code to accompany communications in both directions: device 302 would include an application code in its communications with server 104, and server 104 would include that application code in its communications with device 302. In some circumstances, however, it might be found convenient to simplify this procedure somewhat. Thus, for example, in a configuration in which a reader 150 is used to direct communications to a selected one of a plurality of servers 104, the selected server 104 might not need to receive an application code, since all communications directed to that server by that reader 150 would (if standardized application codes are in use) necessarily have an identical application code. Thus, in general device 302 will send or show an appropriate application code along with an appropriate one-time transaction code, the combination thus providing a sort of ‘address’ to ensure that the emitted one-time transaction code gets to an appropriate application. However, in situations where application selection is unambiguous, sending an application code along with a transaction code may be unnecessary.

It is noted that an additional processing layer, which might be called an “application types” layer, is also contemplated. Thus, a ‘first layer’ application might identify itself (through a reader 150 peripheral for example) to a device 302 as a payment application, perhaps associated with a cash register in a store. A user might then provide biometric input to his device 302 and then choose which of several credit-card applications installed on his device 302 is to be used. That selection would result in device 302 passing an application code to the first-layer payment application, which application would then establish communication with a second-layer application server running a specific credit card application. A combined communication comprising a payment request sent by the payment application and a one-time transaction code supplied by device 302 might then be sent to the second-layer credit card application server, which would then authorize the transaction.

Reference is again made to FIG. 10, noting the optional use of connection codes 450.

According to an optional embodiment presented in FIG. 10, each device 302 is provided with a set 452 of “connection codes” (e.g. 20 connection codes), here designated connection codes 450. Each connection code 450 is useable to manage communications with a single application. Connection codes 450 may be provided to device 302 when device 302 is manufactured, or alternatively may be installed in device 302 subsequent to manufacture by a manufacturer or supplier of devices 302, preferably under appropriate commercial arrangements with end users and/or with marketers of applications services.

Under the embodiment presented by FIG. 10, a connection code 450 is required to enable communication between a device 302 and an application. Connection code 450 serves as application code 410. Under a contemplated commercial embodiment, an application owner/supplier buys the right to communicate with a specific device 302 by purchasing from a supplier of device 302 services a connection code 450 installed on that device 302, for use as an application code 410 for that application owner/supplier's application 305. Optionally, records can be kept by the supplier of devices 302, recording what applications are installed on each device 302, to facilitate replacement in case of loss.

Each application keeps a record of purchased connection codes, which it can then use as an application number, as described above, for communication with devices 302. The procedures for authorizing transactions are as described above, with the difference that application numbers are (in this embodiment) not standard across all devices 302, but rather specific to each device 302. Thus for a particular device 302 to recognize an application, that application must have purchased or otherwise acquired access to one of the connection codes installed on that particular device 302. Similarly, for a particular device 302 to address a particular application 305, that application 305 must have prior knowledge of one of the connection codes installed on that particular device 302, and be ready to recognize that code as an application code addressing that particular application 305. Thus, connection codes, and control of the knowledge of connection codes installed in a device 302, can be used as a commercial tool by which a manufacturer and/or marketer of devices 302 can regulate use of those devices by various application sellers or other commercial or non-commercial clients.

This, connection codes serve as a tool for managing commercial relations between a supplier of devices 302 and suppliers of application services. Connection codes may be time limited, or may be limited in number of instances of use. These limitations are similar to those described above as being useable to manage relations between application suppliers and end users, yet in the embodiment now described the time and/or use limitation is conceived as being used to regulate commercial relations between application suppliers and a supplier of devices 302.

Thus, in a preferred embodiment, each device 302 is supplied with a set (e.g. 20) of unique connection codes 450. An application-supplier wanting to use a device 302 to authorize transactions purchases the right to do so from a device 302 supplier, who supplies to the application supplier a connection code for each device 302 which is to receive services from that application supplier. The connection code 450 received by the application supplier enables his application to communicate with a specific user's specific device 302. Using that connection code his application can communicate with that specific device 302. The particular device 302 will present that code 450 to his application each time it requests authorization of a transaction, and his application will use that code 450 to establish communication between application and that particular device 302. If a device 302 is lost or stolen, device supplier 302 has a record of what applications were installed thereon, and can restore them. Of course if a device 302 is lost or stolen, all codes in all applications installed thereon can be cancelled immediately and automatically.

In an alternative embodiment of connection codes, it is possible to use unique codes supplied by an application rather than (or in addition to) codes supplied on device 302 by the device manufacturer. Under this option, once communication has been established between device 302 and an application 305 (under standard codes or under unique connection codes as described above), application 305 may then supply a new unique application code which will be remembered by device 302 and used as application-identifying code in subsequent transactions between that application and that device 302. This option continues the increased security provided by use of connection codes as described above, but removes the supplier of device 302 from his position as intermediary between application supplier and end user: once the card's built-in connection code (or a standard code) is used to establish first communication between device and application, and that application has then supplied a new unique application-identifying code to device 302, then only that new unique application-identifying code will identify that application to that device 302. Under this option, then, the code used to manage communications between application and device 302 are unknown to the device 302 supplier once a first initializing communication between device and application has been established.

Various combinations of standard codes and card-supplied connection codes and application-supplied connection codes are possible. Thus a standard code could be used to open a transaction between card and application, but a unique connection code could then be required to establish certain privileged communications, to change card parameters, to open certain transactions, etc. As an example, one might enable a device 302 to freely display driver's license information (with, or alternatively without, biometric input recognition), yet require a connection code held only by the Motor Vehicle department to enable changing of driver's license details.

In another optional embodiment, connection codes may be used only to establish initial communication between an application 305 and a particular device 302, and to authorize installation of transaction codes in device 302. Once transaction codes are installed, a standard application number might be used during actual transactions.

FIG. 10 presents an additional code exchange mechanism useful for further securing communications between device 302 and servers 104. This code exchange mechanism is termed “double verification”.

Double verification provides a device/application communication scheme even more secure than the connection code scheme described above. Double verification is two-way identification verification used for each transaction. According to the double verification protocol, and using techniques discussed hereinabove, not only does an authorization system utilized device 102/302 to identify a user to authorization procedures of an application, but that authorization system also identifies each application to each device 302. According to double verification protocols, during installation of transaction codes (or of a transaction code rule) in device 302, each application also installs a set 462 of application verification codes 460 (or an application verification code rule 461). These codes function similarly to transaction codes 142, but inversely. Whereas transaction codes 142 are useable by an application to verify the identify of a device 302, and thereby to verify identity of a user of device 302, application verification codes 460 are useable by device 302 to verify that communications received, ostensibly originating from a server 104 running a selected application 305, indeed truly originate from that server and that application. That is, application verification codes 460 are useable by device 302 to be sure it is communicating with the application it thinks it is communicating with. Thus, if one were filling out a credit card form for a purchase from Amazon over the Internet, an owner of a device 302 with double verification installed could be certain without doubt that he is in fact sending his valid transaction code to Amazon, and not to a computer hacker who would misuse it.

Under double verification, each message from an application 305 to a device 302 comprises a non-repeatable non-guessable application verification code 460 known to device 302 because device 302 received it during the application initialization phase of device 302 initialization. An application identity verifier 470 on device 302 compares a received application verification code 460 to a stored set of application verification codes installed for this application at installation time. Application verification codes 460 are preferably one-time codes similar to transaction codes 142, and are similarly disqualified (invalidated) both on device 302 and on server 104, after one-time use, thereby preventing re-use. In similarity to transaction codes, application verification codes 460 may, in an alternative embodiment, be generated according to an application verification code generation rule (rather than downloaded) using methods discussed in detail in the discussion of FIG. 4 hereinabove.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for authorizing transactions of a plurality of applications, comprising:
(a) a set of at least one application servers each operable to authorize transactions of at least one application, each transaction authorization being dependent upon receipt, by said authorizing server, of a transmitted code, and further being dependent upon verification by said server that said received code is an appropriate transaction code for said selected application; and
(b) at least one user device operable to verify identity of a user by comparing real-time biometric input from said user with data derived from biometric input provided by said user during initialization of said user device, said user device being further operable to select an application from among a plurality of applications and to emit a non-repeating non-guessable transaction code appropriate for said selected application, emission of said transaction code being dependent upon said biometric verification of user identity.

2. The system of claim 1, wherein said user device is operable to select said selected application according to user input provided by a user to a user interface of said user device.

3. The system of claim 1, wherein said user device is operable to select said selected application according to data input received from an electronic device external to said user device.

4. The system of claim 3, wherein said user device is operable to select said selected application according to an application code emitted by one of said plurality of application servers, said application code serving to identify said selected application.

5. The system of claim 4, wherein said application code is received by said user device from an electronic communication, is stored in a memory of said user device, and is subsequently used to identify an application code received by said user device during communication with said one of said plurality of application servers.

6. The system of claim 4, wherein said application code is a code installed in a memory of said user device prior to initialization of said user device.

7. The system of claim 1, wherein said user device is operable to transmit to a server device of said set of server devices a transaction authorization request which comprises said transaction code and further comprises an application code identifying said selected application.

8. The system of claim 7, wherein said application code is received by said user device through an electronic communication, is stored in a memory of said user device, and is subsequently retransmitted by said user device as a component of a transaction authorization request transmitted to a server device.

9. The system of claim 1, wherein at least one of said server devices is operable to transmit to said user device an application code recognizable by said user device as identifying an application for which said one of said plurality of server devices is operable to authorize transactions.

10. The system of claim 7, further comprising a plurality of said user devices, and wherein a same application code identifies a same application to each of said plurality of user devices.

11. The system of claim 7, further comprising a plurality of said user devices, and wherein each said application codes is unique to one of said applications and is further unique to one of said plurality of user devices.

12. The system of claim 1, wherein said at least one application server is operable to transmit said transaction code to said user device, and said user device is operable to retransmit said received transaction code to said application server as a component of a transaction authorization request.

13. The system of claim 1, wherein said application server is operable to generate said transaction code according to a rule, said application server is further operable to transmit said rule to said user device and said user device is operable to receive said rule from said application server and is further operable to emit a transaction code generated according to said received rule.

14. The system of claim 1, wherein said user device is further operable to communicate said transaction code to said application server.

15. The system of claim 14, wherein said communication of said transaction code to said application server is communication selected from a group consisting of Internet communication, radio communication, LAN communication, WAN communication, and infra-red communication.

16. The system of claim 1, wherein initialization of ability of at least one application server of said set of application servers to communicate with said user device is dependent on transmission of a connection code from said at least one application server to said user device, said transmitted code being recognizable as a connection code by successful comparison with a connection code is installed in said user device prior to said initialization.

17. The system of claim 1, wherein at least one of said application servers is operable to transmit to said user device a communication which comprises a non-repeating non-guessable code, and said user device is operable to utilize said received code to verify that said received communication originated from said one of said application servers.

18. The system of claim 1, wherein said user device is portable.

19. The system of claim 18, wherein said user device is embodied as a card in credit-card format.

20. The system of claim 1, wherein said user device is operable to present, in graphic format on a display of said device, user-identifying information stored in a memory of said user device.

21. The system of claim 20, said presentation of said user-identifying information being dependent upon said biometric verification of user identity.

22. The system of claim 20, wherein said user device is enabled to change information stored in said memory of said user device only after biometric verification of user identity.

23. The system of claim 20, wherein a user of said user device is enabled to change information stored in said memory of said user device only after biometric verification of user identity.

24. A user device for identifying a user during authorization of a transaction, comprising:
(a) a biometric input device operable to receive first biometric input from a first user during initialization of said user device and further operable to receive second biometric input from a second user requesting authorization of a transaction;
(b) a first memory operable to store data derived from said first biometric input;
(c) a processor operable to determine, by comparing said second biometric input with said stored data, whether said first user and said second user are a same user;
(d) a transaction code generator operable to generate a non-repeating non-guessable code recognizable by an application server to which it is addressed as being a transaction code appropriate for authorizing a transaction of an application running on said server; and
(e) a selection mechanism for selecting a selected application from among a plurality of applications,
said user device being operable to emit a transaction code appropriate for authorizing a transaction of an application selected by said selection mechanism if and only if said processor determines that said first user and said second user are a same user.

25. The device of claim 24, wherein said transaction code generator is enabled to generate said non-repeating non-guessable code during a pre-set limited time duration following each instance of determination by said processor that said first user and said second user are a same user.

26. The device of claim 24, further comprising a user interface useable by a user to indicate a choice of applications, and wherein said application selection mechanism is operable to select an application from among a plurality of applications according to a choice expressed by a user through said user interface.

27. The device of claim 24, wherein said selection mechanism is operable to select an application according to an application code received from an external electronic device.

28. The device of claim 24, embodied in credit-card format.

29. A commercial method providing a transaction authorization service for a plurality of applications, comprising:
(a) providing a plurality of user devices each operable store data derived from biometric input from a user supplied during initialization of said user device, each user device further being operable to verify identity of a user by comparing real-time biometric input supplied by said user to said stored data, said user device further being operable to select an application from among a plurality of applications and further being operable to emit a non-repeating non-guessable transaction code appropriate for authorizing a transaction of said selected application, said emission of said transaction code being dependent on said verification of user identity; and
(b) providing to an application operator a connection code recognizable by one of said plurality of user devices, which connection code enables communication between at least one of said plurality of user devices and a server device operable to authorize a transaction of an application running on said server device upon receipt of a transaction authorization request comprising said transaction code.

30. The method of claim 29, wherein said providing of said connection code to said application operator is in exchange for financial compensation.

31. The method of claim 29, wherein transmission of said connection code from a server device to one of said plurality of user devices enables transfer of information from said server device to said user device, which information enables said user device subsequently to transmit to an application server running an application a transaction authorization request which comprises a non-repeating non-guessable transaction code recognizable by said application server as being appropriate for authorizing a transaction of said application.

32. The method of claim 29, further comprising enabling said application operator to utilize said connection code to provide to said one of said plurality of user devices an application code, which application code enables said user device to communicate with a server device running an application.

33. The method of claim 32, wherein said connection code is disqualified from further by said one of said plurality of user devices when said application code is provided to said user device.
